(19) United States
(12) Patent Application Publication
(10) Pub. No.: US 2025/0322444 A1
(43) Pub. Date: Oct. 16, 2025

(54) MACHINE LEARNED MODEL FOR DETERMINING SEGMENTING OPTIONS TO FULFILL BULK ORDERS

(71) Applicant: Maplebear Inc., San Francisco, CA (US)

(72) Inventors: Shaun Navin Maharaj, Vaughan (CA); Brent Scheibelhut, Toronto (CA); Madeline Mesard, New York, NY (US)

(21) Appl. No.: 18/634,757

(22) Filed: Apr. 12, 2024

(51) Int. Cl. G06Q 30/0601; G06Q 10/08

(52) U.S. Cl. CPC G06Q 30/0635; G06Q 10/08

(57) ABSTRACT

An online concierge system (“the system”) determines that a shopping list from a user client device includes a request for a quantity of an item that exceeds a quantity that can be fulfilled using a single retailer. Responsive to the determination, the system retrieves model inputs based in part on the request. The system determines segmenting options, for fulfilling the request using multiple sources, and their associated costs using a machine learned model and the model inputs. The segmenting options include different combinations of pickers and sources that can be used to fulfill the request. The system provides one or more of the segmenting options and their associated costs to the user client device. Responsive to receiving, from the user client device, a segmenting option of the one or more segmenting options, the system fulfills the request in accordance with the segmenting option.

### BACKGROUND

In the current retail landscape, businesses and establishments (schools, churches, community centers, etc.) frequently encounter obstacles in satisfying their order demands due to limitations in existing fulfillment and replacement models. These challenges are particularly evident in instances of bulk orders where orders comprise large item quantities, which cannot be catered for by a single source. Conventional solutions do not effectively leverage available resources, such as shopper capabilities and expansive datasets, to make intelligent decisions about selecting which sources to fulfill such bulk orders. In particular, there are no conventional methods to predict conditions associated with the fulfillment process of bulk orders, such as travel times associated with different selections of sources. Consequently, these businesses are deprived of efficient, reliable solutions that could allow them to meet their inventory needs.

### SUMMARY

In accordance with one or more aspects of the disclosure, a machine learned model for determining segmenting options to fulfill bulk orders is described. An online concierge system monitors shopping lists from users making orders to determine whether the users are intending to buy one or more items in bulk (e.g., quantities generally found in business-to-business situations such that a single retailer location is not able to source the requested quantities of items). The online concierge system may determine that a shopping list from a user client device associated with a user includes a request for an item in bulk. Responsive to the determination, the online concierge system may retrieve model inputs based in part on the request. The online concierge system may apply the model inputs to a machine learned model (e.g., fulfillment model) to determine segmenting options to fulfill the request, and in some embodiments their associated costs. The segmenting option includes different combinations of pickers and sources (e.g., retailers, CPG warehouses) that can be used to fulfill the request.

The online concierge system provides one or more of the segmenting options and their associated costs to the user client device. The user client device presents the one or more of the segmenting options and their associated costs. Responsive to receiving, from the user client device, a segmenting option of the one or more segmenting options, the online concierge system fulfills the request in accordance with the received segmenting option.

In some aspects, the techniques described herein relate to a method, performed at a computer system including a processor and a non-transitory computer readable medium, including: determining that a shopping list from a user client device includes a request for a quantity of an item that exceeds a quantity that can be fulfilled using a single retailer; and responsive to the determination, retrieving model inputs based in part on the request, wherein the model inputs include availability information for the item at various sources including a consumer packaged goods (CPG) warehouse and one or more retailers, determining segmenting options, for fulfilling the request using multiple sources, and their associated costs using a machine learned model and the model inputs, wherein the segmenting options include different combinations of pickers and sources that can be used to fulfill the request, providing one or more of the segmenting options and their associated costs to the user client device, wherein the user client device presents the one or more of the segmenting options and their associated costs, and responsive to receiving, from the user client device, a segmenting option of the one or more segmenting options, fulfilling the request in accordance with the segmenting option.

In some aspects, the techniques described herein relate to a computer program product including a non-transitory computer readable storage medium having instructions encoded thereon that, when executed by a processor of a computer system, cause the computer system to: determine that a shopping list from a user client device includes a request for a quantity of an item that exceeds a quantity that can be fulfilled using a single retailer; and responsive to the determination, retrieve model inputs based in part on the request, wherein the model inputs include availability information for the item at various sources including a consumer packaged goods (CPG) warehouse and one or more retailers, determine segmenting options, for fulfilling the request using multiple sources, and their associated costs using a machine learned model and the model inputs, wherein the segmenting options include different combinations of pickers and sources that can be used to fulfill the request, provide one or more of the segmenting options and their associated costs to the user client device, wherein the user client device presents the one or more of the segmenting options and their associated costs, and responsive to receiving, from the user client device, a segmenting option of the one or more segmenting options, fulfill the request in accordance with the segmenting option.

In some aspects, the techniques described herein relate to a computer system including: a processor; and a non-transitory computer readable storage medium having instructions encoded thereon that, when executed by the processor, cause the processor to: determine that a shopping list from a user client device includes a request for a quantity of an item that exceeds a quantity that can be fulfilled using a single retailer; and responsive to the determination, retrieve model inputs based in part on the request, wherein the model inputs include availability information for the item at various sources including a consumer packaged goods (CPG) warehouse and one or more retailers, determine segmenting options, for fulfilling the request using multiple sources, and their associated costs using a machine learned model and the model inputs, wherein the segmenting options include different combinations of pickers and sources that can be used to fulfill the request, provide one or more of the segmenting options and their associated costs to the user client device, wherein the user client device presents the one or more of the segmenting options and their associated costs, and responsive to receiving, from the user client device, a segmenting option of the one or more segmenting options, fulfill the request in accordance with the segmenting option.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates a block diagram of an example flow for determining segmenting options using a fulfillment model, according to one or more embodiments.

FIG. 4 illustrates an example ordering interface presenting a plurality of segmenting options and their associated costs, in accordance with some embodiments.

FIG. 5 is a flowchart for a method of determining segmenting options using a fulfillment model, in accordance with some embodiments.

### DETAILED DESCRIPTION

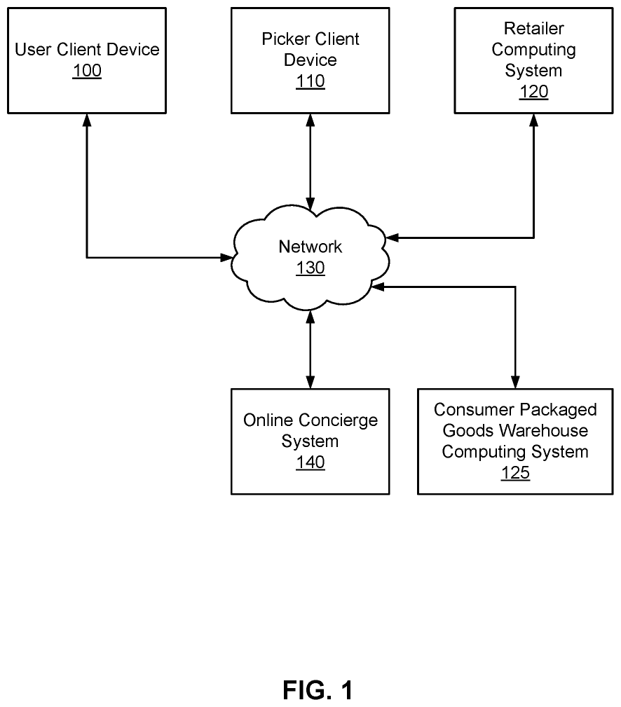

FIG. 1 illustrates an example system environment for an online concierge system 140, in accordance with one or more embodiments. The system environment illustrated in FIG. 1 includes a user client device 100, a picker client device 110, a retailer computing system 120, a consumer packaged goods (CPG) warehouse computing system 125, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, users, pickers, retailers, and CPG warehouses may be generically referred to as “users” of the online concierge system 140. Additionally, while one user client device 100, picker client device 110, CPG warehouse computing system 125, and retailer computing system 120 are illustrated in FIG. 1, any number of users, pickers, CPG warehouses and retailers may interact with the online concierge system 140. As such, there may be more than one user client device 100, picker client device 110, retailer computing system 120, CPG warehouse computing system 125, or some combination thereof.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, means a good or product that can be provided to the user through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive incentives, coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, the CPG warehouse computing system 125, the online concierge system 140, or some combination thereof. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from sources as described in the order. A source may be, e.g., a retailer or a CPG warehouse. The picker client device 110 presents the items that are included in the user's order to the picker in a collection interface. The collection interface is a user interface that provides information to the picker on which items to collect, and from which source to collect them, for a user's order and the quantities of the items. In some embodiments (e.g., bulk order for an item), the collection interface may instruct one picker to collect a first portion of a requested quantity of an item from a first source, and a remaining portion of the requested quantity of the item from a different source. In some embodiments, the collection interface provides multiple orders from multiple users for the picker to service at the same time from the same source location. The collection interface further presents instructions that the user may have included related to the collection of items in the order. Additionally, the collection interface may present a location of each item in the source location (e.g., retailer location or CPG warehouse location), and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the source location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. Where a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user such that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a source location and delivers the order to the delivery location for the order. In some embodiments, more than one person may serve the role as a picker for an order. For example, multiple people may collect the items at the source location for a single order. In some embodiments, multiple pickers may service a single order. For example, one picker collects a first portion of a requested quantity of an item from a first source, and another picker collects a remaining portion of the requested quantity of the item from a second source that is different from the first source. In some embodiments, the person who delivers an order to its delivery location may be different from the person or people who collected the items from the source location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

The retailer computing system 120 is a computing system operated by a retailer that interacts with the online concierge system 140. As used herein, a “retailer” is an entity that operates a “retailer location,” which is a store, warehouse, or other building from which a picker can collect retail items. The retailer computing system 120 stores and provides item data to the online concierge system 140 and may regularly update the online concierge system 140 with updated item data. For example, the retailer computing system 120 provides item data indicating which items are available a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The CPG warehouse computing system 125 is a computing system operated by a CPG warehouse that interacts with the online concierge system 140. As used herein, a “CPG warehouse” is an entity that operates a “CPG warehouse location,” which is a warehouse, or other building from which a picker can collect items. The CPG warehouses stock large quantities of items that are distributed in a business-to-business fashion to retailer locations and/or users for sale. As described herein, for bulk orders of an item, the CPG warehouse computing system 125 may allow pickers to directly source items from a CPG warehouse that stocks that item for distribution. The CPG warehouse computing system 125 stores and provides item data to the online concierge system 140 and may regularly update the online concierge system 140 with updated item data. For example, the CPG warehouse computing system 125 provides item data indicating which items are available at a CPG warehouse location and the quantities of those items. Additionally, the CPG warehouse computing system 125 may transmit updated item data to the online concierge system 140 when an item is no longer available at the CPG warehouse location. Additionally, the CPG warehouse computing system 125 may provide the online concierge system 140 with updated item prices, sales, or availabilities. Additionally, the CPG warehouse computing system 125 may receive payment information from the online concierge system 140 for orders serviced by the online concierge system 140. Alternatively, the CPG warehouse computing system 125 may provide payment to the online concierge system 140 for some portion of the overall cost of a user's order (e.g., as a commission).

The user client device 100, the picker client device 110, the retailer computing system 120, the CPG warehouse computing system 125, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from one or more retailers, one or more CPG warehouses, or some combination thereof. The online concierge system 140 receives orders from a user client device 100 through the network 130. The online concierge system 140 selects one or more pickers to service the user's order and transmits some or all of the order to one or more picker client devices that are associated with the one or more pickers. Each of the one or more pickers collects their portion of the ordered items from one or more source locations (e.g., retailer location, CPG warehouse) and delivers the ordered items to the user (or in some case a picker to deliver a consolidated order to the user). The online concierge system 140 may charge a user for the order and provides portions of the payment from the user to the one or more pickers and the one or more sources.

As an example, the online concierge system 140 may allow a user to order groceries from a grocery store retailer. The user's order may specify which groceries they want delivered from the grocery store and the quantities of each of the groceries. The user client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140.

The online concierge system 140 monitors shopping lists from users making orders to determine if a user is intending to buy one or more items in bulk. As used herein, buying an item in bulk refers to quantities generally found in business-to-business situations such that a single retailer is not able to source the requested quantities of items. The online concierge system 140 may make the determination by comparing the requested quantity of the item to a bulk item threshold value for that item, and based on the comparison determine whether the request is a bulk request for the item.

The online concierge system 140 may determine that a shopping list from a user client device includes a request for a quantity of an item that exceeds a quantity that can be fulfilled using a single retailer. Responsive to the determination, the online concierge system 140 may retrieve model inputs (e.g., buy-it-again data, picker data, item data, etc.) based in part on the request. The online concierge system 140 may determine segmenting options for fulfilling the request using multiple sources, and their associated costs using a machine learned model and the model input. A segmenting option describes how a requested quantity of an item can be sourced. The segmenting options include different combinations of pickers and sources that can be used to fulfill the request.

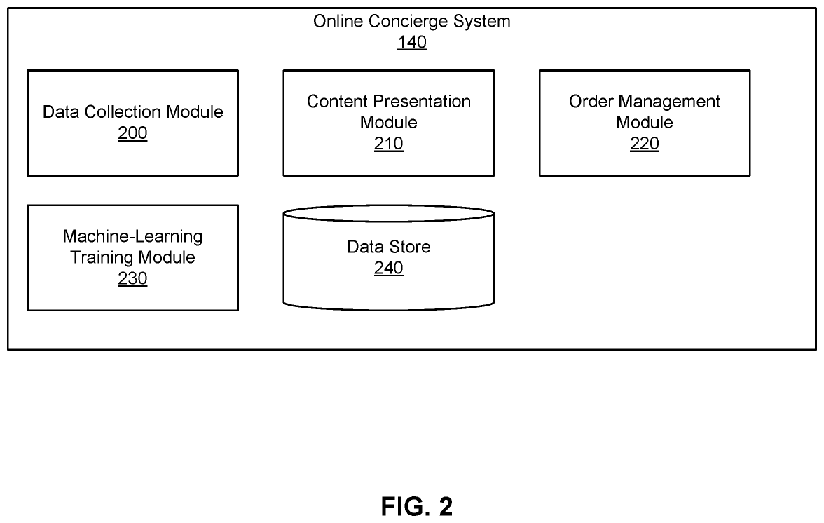

The online concierge system 140 provides one or more of the segmenting options and their associated costs to the user client device 100. The user client device 100 presents the one or more of the segmenting options and their associated costs. Responsive to receiving, from the user client device 100, a segmenting option of the one or more segmenting options, the online concierge system 140 fulfills the request in accordance with the received segmenting option. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, shopping history, favorite items, or stored payment instruments. The user data also may include default settings established by the user, such as a default retailer/retailer location, payment instrument, delivery location, or delivery timeframe. The data collection module 200 may collect the user data from sensors on the user client device 100 or based on the user's interactions with the online concierge system 140.

User data may also include information about an organization associated with a plurality of different users. For example, user data may include a name of the organization, titles of users associated with the organization, addresses of the organization, delivery location(s) for the organization, delivery timeframe(s) for the organization, buy-it-again (BIA) data for items ordered in bulk for the organization, favorite items that are ordered in bulk for the organization, favorite items that ordered for the organization that are not ordered in bulk, stored payment information for the organization, organization shopping preferences, etc. BIA data describes items that a user has purchased in the past in bulk, and is likely to purchase again in the future.

The data collection module 200 may infer some user data for an organization based in part on the user data of users who are associated with the organization. For example, an organization may be a school, and various teachers, administrators, etc., may be users that order items in bulk for the organization. The data collection module 200 may use user data (e.g., shopping histories) for the various users (e.g., teachers, administrators, etc.) associated with the organization to determine that each year the organization orders the same items (e.g., cheese pizzas, several types of beverages, etc.) in bulk on a particular date (e.g., for a pizza party to celebrate the end of a school year). The data collection module 200 may use this determination to infer BIA data (i.e., the organization generally orders 50 cheese pizzas in the beginning of May) for the organization. In another example, the data collection module 200 may use user data (e.g., shopping histories) for the various users (e.g., teachers, administrators, etc.) associated with the organization to determine that the school caters to particular food categories (e.g., Kosher or Halal).

The data collection module 200 also collects item data, which is information or data that identifies and describes items that are available at a source location (e.g., retailer location, a CPG warehouse location). The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a CPG warehouse computing system 125, a picker client device 110, the user client device 100, or some combination thereof.

In some embodiments, the item data may also include bulk item threshold information for items. Bulk item threshold information are bulk items thresholds that correspond to different items and/or item categories that can be used to determine whether a requested quantity of an item would constitute a bulk order for the item (i.e., cannot be fulfilled by a single retailer). The data collection module 200 may generate a bulk item threshold for an item based on, e.g., historical quantities availability of the item at one or more retailers, maximum order sizes allowed by retailers for the item, etc. In some embodiments, the bulk item threshold for an item may differ based on geographic location of the user. For example, a user who is located in a large city may have a higher availability of the item at local retailers relative to a user who is located in a rural area whose retailers have a much lower availability of the item. Accordingly, a bulk item threshold for the item for the user in the city may be much higher than a bulk item threshold for the same item for the user in the rural location.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a user rating for the picker, vehicle type of the picker (e.g., bicycle, make/model of car, etc.), size of available cargo space in a vehicle of the picker, picker efficiency score, which sources (e.g., retailers and/or CPG warehouses) the picker has collected items at, or the picker's previous shopping history. The picker efficiency score gauges a picker's ability to fulfill the order quickly and accurately. The data collection module 200 may calculate the picker efficiency store by evaluating their familiarity with store layouts, product categories, and operational speed. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order.

The content presentation module 210 selects content for presentation to a user. For example, the content presentation module 210 selects which items to present to a user while the user is placing an order. The content presentation module 210 generates and transmits the ordering interface for the user to order items. The content presentation module 210 populates the ordering interface with items that the user may select for adding to their order. In some embodiments, the content presentation module 210 presents a catalog (e.g., an online catalog) of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine learning models and may be stored in the data store 240.

In some embodiments, the content presentation module 210 scores items based on a search query received from the user client device 100. A search query is text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a user based on whether the predicted availability of the item exceeds a threshold.

The order management module 220 monitors shopping lists from users making orders to determine if a user is intending to buy one or more items in bulk as part of their order. The order management module 220 may retrieve a bulk threshold value for each of the one or more items (e.g., from the data store 240), and compare the requested quantities of the one or more items to the corresponding bulk threshold value. For items, where a requested quantity meets or exceeds the corresponding bulk threshold value, the order management module 220 determines that request is a bulk request. And that the requested quantity exceeds a quantity that can be fulfilled using a single retailer.

Responsive to the determination, the order management module 220 may retrieve model inputs based in part on the request. The model inputs may include, e.g., user data (e.g., BIA data), picker data (e.g., picker efficiency scores, available cargo size of picker vehicles, etc.), item data (e.g., availability of the item within a threshold distance from the delivery address), or some combination thereof. In some embodiments, the model inputs may also include a requested delivery timeframe (i.e., a date and/or time requested by a user for delivery), whether a user requests fulfillment via a single delivery, some other information pertinent to a fulfillment model, or some combination thereof.

The order management module 220 may use a fulfillment model to determine segmenting options for a requested item. The fulfillment model is a machine learned model that is configured to use the retrieved model inputs to determine segmenting options for fulfilling a request for a quantity of an item. A segmenting option describes how a requested quantity of an item can be sourced. The segmenting options include different combinations of pickers and sources that can be used to fulfill the request.

In some embodiments, a segmenting option may also include other information (e.g., estimated delivery times, percent found, substitutions, etc.). Percent found refers to a percentage of the requested quantity for the item that is sourced using a particular segmenting option (e.g., 100% would mean that the segmenting option would be able to provide all of the requested amount of the item). Substitutions refers to substituting some or all of the requested item within a related item (e.g., different brand of the item). For example, if the request was for 100 bags of RUFFLES chips, a substitution may be for 100 bags of LAYS chips. The fulfillment model may generate substitutions that have greater availability of the requested item, are cheaper, etc.

In one example, to fulfill a request for 100 units of an item, the fulfillment model may identify three different segmenting options. A first segmenting option has a single picker that picks up 70 units of the item at a first retailer, and the remaining 30 units at a second retailer. A second segmenting option has a first picker that picks up 70 units of the item at the first retailer, and a second picker who picks up the remaining 30 units at the second retailer. And a third segmenting option has a single picker that picks up 100 units of the item at a CPH warehouse.

In some embodiments, the fulfillment model also determines associated costs for each of the segmenting options. In other embodiments, a second model may be used to determine costs for each of the segmenting options.

The order management module 220 may select one or more of the segmenting options output from the fulfillment model for providing to the user client device 100. The order management module 220 may, e.g., apply one or more filters to remove segmenting options that likely would not be of interest to the user. For example, removing segmenting options with long delivery times (e.g., more than a week, outside of requested delivery timeframe), costs above some threshold value (e.g., 40% or more above retail price), etc. In some embodiments, the order management module 220 may rank the segmenting options based in part on their associated costs and number of sources to fulfill the request. The order management module 220 may select the one or more of the segmenting options to provide to the user client device 100 based in part on the ranking.

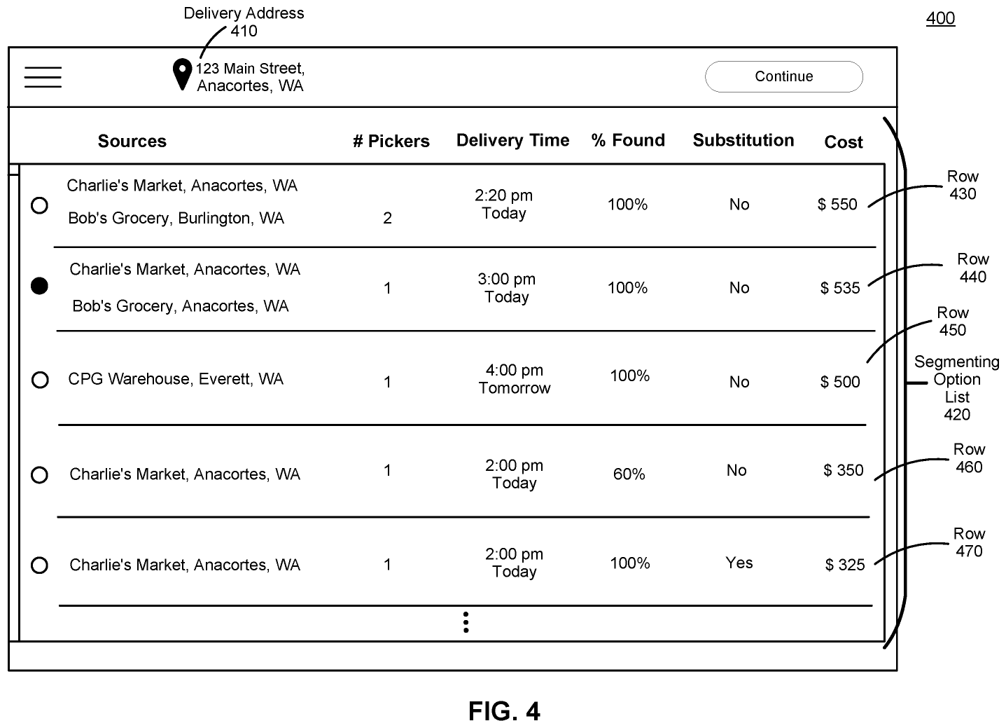

The order management module 220 provides one or more of the segmenting options and their associated costs to the user client device 100. In some embodiments, the order management module 220 provides all of the segmenting options and their associated costs to the user client device 100. The user client device 100 presents the one or more of the segmenting options and their associated costs for the user to select a segmenting option of the one or more segmenting options. An example illustration of a user client device presenting segmenting options is described below with regard to FIG. 4. Responsive to receiving from the user client device 100 a segmenting option, the order management module 220 fulfills the request in accordance with the segmenting option. For example, if the selected segmenting option is for a single picker to go to multiple sources in order to source a requested quantity of an item, the order management module 220 would assign a picker, and instruct the picker to source specific quantities of the item from each of the multiple sources. Additional details regarding how the order management module 220 fulfills an order are described below.

In some embodiments, the order management module 220 determines an item of interest to the organization based in part on BIA data and purchase preferences for the organization. The order management module 220 may predict a quantity of the item of interest based in part on the BIA data and the purchase preferences for the organization, where the predicted quantity would constitute a bulk item request (e.g., exceeds a quantity that can be fulfilled using a single retailer). The order management module 220 may predict a date that the organization would request delivery for the item, and generate an incentive that provides a discount to pre-order the item if ordered at least a threshold time before the predicted date. The order management module 220 may provide the incentive to the user client device 100 for presentation. By providing the user with an incentive to pre-order items in bulk, the order management module 220 can facilitate availability of those items to the user at lower costs.

The order management module 220 manages orders for items from users. The order management module 220 receives orders from a user client device 100 and assigns the orders to pickers for service based on picker data. For example, the order management module 220 assigns an order to a picker based on the picker's location and the location of the source location from which the ordered items are to be collected. In another example, the order management module 220 assigns different parts of an order to different pickers based on, e.g., a selected segmenting option. The order management module 220 may also assign some or all of an order to a picker based on how many items are in the order, a vehicle operated by the picker, a cargo capacity of a vehicle operated by the picker, the delivery location, the picker's preferences on how far to travel to deliver an order, the picker's ratings by users, or how often a picker agrees to service an order.

In some embodiments, the order management module 220 determines when to assign all or some of an order to a picker based on a delivery timeframe requested by the user with the order. The order management module 220 may compute an estimated amount of time that it would take for a picker to collect the items of the order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns some or all of an order to a picker, the order management module 220 transmits the part of the order assigned to the picker to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the source location. When the picker arrives at the source location, the order management module 220 transmits the portion of the order assigned to the picker to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit to the picker client device 110 instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items that were assigned to the picker for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of their order. In some embodiments, the order management module 220 computes an estimated time of arrival for the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the one or more sources.

The machine learning training module 230 trains machine learning models used by the online concierge system 140. The online concierge system 140 may use machine learning models (e.g., the fulfillment model) to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include user data, picker data, item data, order data, or some combination thereof. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores user data, item data, order data, bulk threshold values, and picker data for use by the online concierge system 140. The data store 240 also stores trained machine learning models (e.g., the fulfillment model) trained by the machine learning training module 230. For example, the data store 240 may store the set of parameters for a trained machine learning model on one or more non-transitory, computer-readable media. The data store 240 uses computer-readable media to store data, and may use databases to organize the stored data.

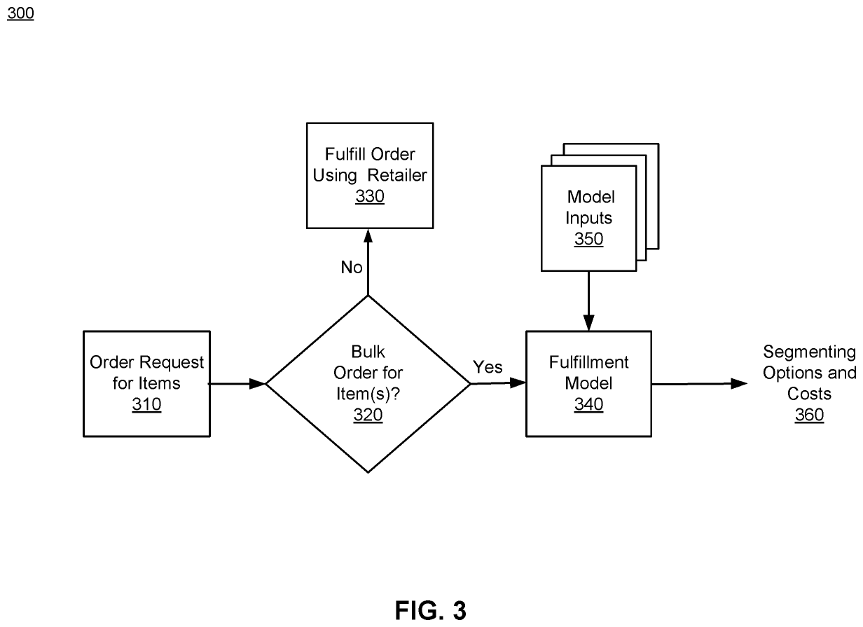

FIG. 3 illustrates a block diagram 300 of an example flow for determining segmenting options using a fulfillment model, according to one or more embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

The online concierge system receives 310 a request for items as part of a shopping list of an order at a retailer (Farmers' Market). The request is from a client user device (e.g., the client user device 100) that is associated with a user. The shopping list includes one or more items, and requested quantities for each of those items.

The online concierge system determines 320 whether any of the requested quantities of items would constitute a bulk order. The online concierge system retrieves from a data store (e.g., the data store 240) a bulk threshold value for each of the items.

The online concierge system compares the requested quantities of the items to the corresponding bulk threshold values of the items. In cases where none of the requested item quantities exceed their corresponding bulk threshold values, the online concierge system proceeds to fulfill 330 the order for the items using the retailer (e.g., Farmers' Market). For example, the requested quantity of items may be 1 case of cola and 1 bag of tortilla chips, and the corresponding bulk threshold values may be 30 cases of cola and 40 bags of tortilla chips. And as 1 case of cola is less than 30 cases, and 1 bag of tortilla chips is less than 40 bags of tortilla chips, the requested quantities would not constitute a bulk order for either of those items. Accordingly, the online concierge system would fulfill the order for the 1 bag of tortilla chips and 1 case of cola at the Farmers' Market.

In embodiments where at least one item of the items has a requested quantity that meets or exceeds the corresponding bulk threshold value, the order management module 220 determines that request for the at least one item is a bulk request. The bulk request for the item is provided to a fulfillment model 340. In some embodiments, other items that are not a bulk request can be fulfilled 330 using the retailer. Continuing with the above example, the requested quantity of items may be 8 cases of cola and 100 bags of tortilla chips, and the corresponding bulk threshold values may be 30 cases of cola and 40 bags of tortilla chips. And while 8 cases of cola are less than 30 cases of cola, 100 bags of tortilla chips are greater than 40 bags of tortilla chips. Accordingly, in this example, the requested quantity of cola does not constitute a bulk order request, but the requested quantity of tortilla chips does constitute a bulk order request.

The online concierge system retrieves 350 model inputs from a data store (e.g., the data store 240) based in part on the request. For example, the online concierge system may retrieve model inputs like, e.g., BIA data, requested delivery timeframe, picker efficiency scores, available cargo size of picker vehicles, availability of the item within a threshold distance from the delivery address, whether a user requests fulfillment via a single delivery, etc. In embodiments, where there is no availability of the item within the threshold distance, the online concierge system may expand the threshold distance incrementally until availability is present for the item.

The online concierge system applies the retrieved model inputs to the fulfillment model 340 to generate segment options and their associated costs. The fulfillment model 340 outputs the segment options and their associated costs 360. In some embodiments, the segmenting options include different combinations of pickers and sources that can be used to fulfill the order for the bulk order of items as well as any items that did not qualify as bulk. For example, a first segmenting option may have a picker assigned to pick up the 8 cases of cola and 50 bags of tortilla chips at the Farmers' Market, and pick up the remaining 50 bags of tortilla chips at Corner Market. And a second segmenting option may have a first picker assigned to pick up the 8 cases of cola and 50 bags of tortilla chips at the Farmers' Market, and a different picker assigned to pick up the remaining 50 bags of tortilla chips at Corner Market. And a third segmenting option may have a single picker that picks up the 8 cases of cola at the Farmers' Market and all of the tortilla chips at a CPG warehouse. The online concierge system provides the segmenting options and their associated costs to the client user device for selection by the user.

FIG. 4 illustrates an example ordering interface 400 presenting a plurality of segmenting options and their associated costs, in accordance with some embodiments. The ordering interface 400 is an embodiment of the ordering interface described above with regard to FIG. 1-3. The ordering interface 400 may be presented on a user client device (e.g., the user client device 100). In the illustrated embodiment, the ordering interface 500 includes a delivery address 410 and a segmenting options list 420. The delivery address 410 is a location ordered items are to be delivered to. In other embodiments, the ordering interface 400 includes different or additional elements. In addition, the functions may be distributed among the elements in a different manner than described.

An online concierge system (e.g., the online concierge system 140) receives a request for an item as part of an order from the user client device. The online concierge system determines that the request for the would constitute a bulk order for that item. The online concierge system may generate, using a fulfillment model, segmenting options and their associated costs for fulfilling the order for a requested quantity of the item, and provides the information to the user client device.

The ordering interface 400 presents the received information via the segmenting options list 420. The segmenting options list 420 is configured to present the plurality of segmenting options and their associated costs. The segmenting options list 420 may include a plurality of rows (e.g., row 430, row 440, row 450, row 460, and row 470), where each row includes information associated with a particular segmenting option. In the illustrated embodiments, each row may include information describing sources that would be used to fulfill the order, a number of pickers that would be tasked to fulfill the order, an estimated delivery time, a percent found of the bulk item, whether a substitution would be made for the bulk item, and estimated costs for the segmenting option. In other embodiments, rows of the segmenting options list 420 may include additional and/or different information.

For example, the segmenting option shown at row 430 sources all of the requested quantity of the item from two retailer locations (i.e., Charlie's Market and Bob's Grocery) using two different pickers (e.g., may have two separate deliveries-one from each picker), with a delivery time of 2:20 pm today at a cost of $550. In contrast, the segmenting option shown at row 440 is cheaper ($535) and uses a single picker, but has a later delivery time (i.e., 3:00 pm today). In the illustrated example, the cheapest segmenting option where 100% of the requested items could be sourced is shown at row 450—where the requested item would be sourced from a CPG warehouse. Note that in this example, this option also has the latest delivery time (e.g., as CPG warehouse is relatively far from the delivery address).

The fastest delivery time is associated with the segmenting option at row 460, where a single picker uses a single source location, but only obtains a percentage of the requested quantity (as the single source location is not able to source the entire requested quantity). This option may be useful to the user where speed is more important than fulfilling the order in its entirety. A potentially cost and/or time effective segmenting option is presented at row 470, where a substitution for the item (e.g., an alternate brand of the requested item) would be used to fulfill the order.

Note that the discussion above is in the context of fulfilling an order for a single item that constituted a bulk item request. In practice, there may be multiple items in an order, and some or all of the items may constitute bulk item requests. By presenting information associated with different segmenting options with potentially different trade-offs, the ordering interface 400 is may be more likely to provide the user with at least one segmenting option that is of interest to the user. For example, if the user wanted 100% of the requested item at the cheapest price and did not care about delivery time—the user would likely be interested in the segmenting option at row 450. In contrast if the user was in a hurry and did not care about cost, the segmenting option at row 430 would likely be of interest. In the illustrated example, the user was interested in getting all of the requested items today, but did not need it by 2:20 pm, so selected the segmenting option associated with row 440.

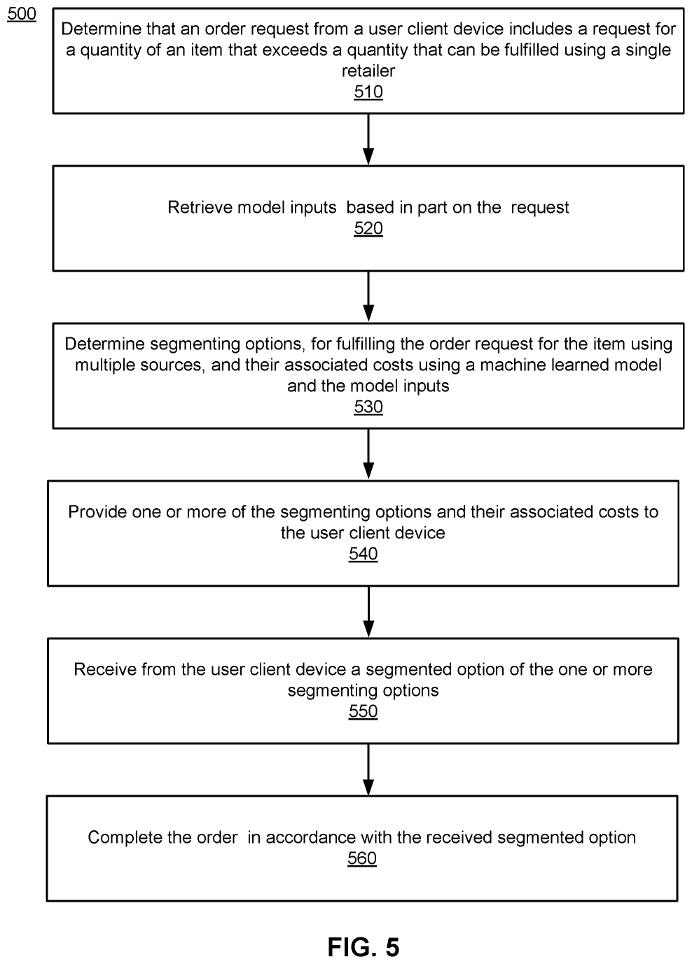

FIG. 5 is a flowchart for a method of determining segmenting options using a fulfillment model, in accordance with some embodiments. Alternative embodiments may include more, fewer, or different steps from those illustrated in FIG. 5, and the steps may be performed in a different order from that illustrated in FIG. 5. These steps may be performed by an online concierge system (e.g., online concierge system 140). Additionally, each of these steps may be performed automatically by the online concierge system without human intervention.

The online concierge system determines 510 that an order request from a user client device includes a request for a quantity of an item that exceeds a quantity that can be fulfilled using a single retailer. The online concierge system may compare bulk threshold value for the item to the requested quantity of the item. In cases where the requested quantity is greater than or equal to the bulk threshold value, the online concierge system determines that the requested order cannot be fulfilled using a single retailer.

The online concierge system retrieves 520 model inputs based in part on the request. The online concierge system may retrieve the model inputs from a data store (e.g., the data store 240). In some embodiments, the model inputs include availability information for the item at various sources including a CPG warehouse and one or more retailers. The retrieved model inputs may also include, e.g., BIA data, requested delivery timeframe, picker efficiency scores, available cargo size of picker vehicles, availability of the item within a threshold distance from the delivery address, whether a user requests fulfillment via a single delivery, etc.

The online concierge system determines 530 segmenting options, for fulfilling the request using multiple sources, and their associated costs using a fulfillment model and the model inputs. The online concierge system applies the model inputs to the fulfillment model which outputs one or more segmenting options, and may also output their associated costs. In some embodiments, the online concierge system may determine the costs for the segmenting options using a separate model. The segmenting options may include different combinations of pickers and sources that can be used to fulfill the request.

The online concierge system may select one or more of the segmenting options to provide to the user client device. For example, the online concierge system may rank the segmenting options based in part on their associated costs and number of sources to fulfill the request. The online concierge system may select the one or more of the segmenting options to provide to the user client device based in part on the ranking.

The online concierge system provides 540 one or more of the segmenting options and their associated costs to the user client device. The user client device presents the one or more of the segmenting options and their associated costs to the user via an ordering interface.

The online concierge system receives 550 from the user client device a segmenting option of the one or more segmenting options. The online concierge system completes 560 the order in accordance with the received segmenting option. For example, the selected segmenting option may have been to use a single picker to gather a first quantity of the item from a first source location (e.g., retailer location) and a remaining quantity of the requested quantity of the item from a second source location (e.g., a different retailer location or CPG warehouse). The online concierge system may instruct the picker to obtain the first quantity of the item from the first source location, then obtain the remaining quantity of the item from the second source location, and then deliver the items to a delivery addressed associated with the order.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a non-transitory computer readable medium, comprising:
determining that a shopping list from a user client device includes a request for a quantity of an item that exceeds a quantity that can be fulfilled using a single source;
generating a plurality of segmenting options for fulfilling the request using multiple sources, wherein the segmenting options include different combinations of pickers and sources that can be used to fulfill the request;
retrieving model inputs based in part on the request, wherein the model inputs include availability information for the item at various sources;
for each of the plurality of segmenting options, applying a machine learned model to the model inputs to identify an associated cost of the segmenting option;
selecting, based on the identified associated costs of the segmenting options, a segmenting option from the plurality of segmenting options; and
fulfilling the request in accordance with the selected segmenting option, wherein the fulfilling comprises dispatching pickers to sources to fulfill the request according to the combination of pickers and sources of the selected segmenting option.

2. The method of claim 1, further comprising:
ranking the segmenting options based in part on their associated costs and number of sources to fulfill the request; and
selecting the one or more of the segmenting options based in part on the ranking.

3. The method of claim 1, wherein selecting the segmenting option from the plurality of segmenting options comprises:
providing the plurality of segmenting options and their associated costs to the user client device, wherein the user client device presents the one or more of the segmenting options and their associated costs; and
receiving a selection of one of the segmenting options from the user device.

4. The method of claim 3, wherein applying a machine learned model to the model inputs to identify an associated cost of the segmenting option comprises estimating, using the machine learned model, delivery times for each of the segmenting options, and wherein providing the plurality of segmenting options and their associated costs to the user client device comprises providing a list of the one or more segmenting options with their associated costs and estimated delivery times.

5. The method of claim 1, wherein the request is for an organization that is associated with one or more users, the method further comprising:
generating buy it again (BIA) data and purchase preferences for the organization using shopping history of the organization generated by the one or more users,
wherein the BIA data and purchase preferences are model inputs used by the machine learned model to determine the segmenting options and their associated costs.

6. The method of claim 5, further comprising:
determining an item of interest to the organization based in part on the BIA data and the purchase preferences for the organization;
predicting a quantity of the item of interest based in part on the BIA data and the purchase preferences for the organization, wherein the quantity exceeds a quantity that can be fulfilled using a single source;
predicting a date that the organization would request delivery for the item;
generating an incentive that provides a discount to pre-order the item if ordered at least a threshold time before the predicted date; and
providing the incentive to the user client device, wherein the user client device presents the incentive.

7. The method of claim 1, wherein retrieving model inputs comprises retrieving one or more of: picker efficiency scores that are associated with the pickers, or sizes of available cargo space in vehicles of the pickers.

8. The method of claim 1, wherein generating a plurality of segmenting options comprises generating a segmenting option for which the combination of sources includes a CPG warehouse.

9. The method of claim 1, wherein generating a plurality of segmenting options comprises generating a segmenting option with a first found rate and a first associated cost, and a second segmenting option with a second found rate and a second associated cost, wherein the first found rate is higher than the second found rate and the first cost is higher than the second cost.

10. A computer program product comprising a non-transitory computer readable storage medium having instructions encoded thereon that, when executed by a processor of a computer system, cause the computer system to perform steps comprising:
determining that a shopping list from a user client device includes a request for a quantity of an item that exceeds a quantity that can be fulfilled using a single source;
generating a plurality of segmenting options for fulfilling the request using multiple sources, wherein the segmenting options include different combinations of pickers and sources that can be used to fulfill the request;
retrieving model inputs based in part on the request, wherein the model inputs include availability information for the item at various sources;
for each of the plurality of segmenting options, applying a machine learned model to the model inputs to identify an associated cost of the segmenting option;
selecting, based on the identified associated costs of the segmenting options, a segmenting option from the plurality of segmenting options; and
fulfilling the request in accordance with the selected segmenting option, wherein the fulfilling comprises dispatching pickers to sources to fulfill the request according to the combination of pickers and sources of the selected segmenting option.

11. The computer program product of claim 10, further comprising instructions that when executed cause the computer system to perform steps comprising:
ranking the segmenting options based in part on their associated costs and number of sources to fulfill the request; and
selecting the one or more of the segmenting options based in part on the ranking.

12. The computer program product of claim 10, wherein selecting the segmenting option from the plurality of segmenting options comprises:
providing the plurality of segmenting options and their associated costs to the user client device, wherein the user client device presents the one or more of the segmenting options and their associated costs; and
receiving a selection of one of the segmenting options from the user device.

13. The computer program product of claim 12, wherein applying a machine learned model to the model inputs to identify an associated cost of the segmenting option comprises estimating, using the machine learned model, delivery times for each of the segmenting options, and wherein providing the plurality of segmenting options and their associated costs to the user client device comprises providing a list of the one or more segmenting options with their associated costs and estimated delivery times.

14. The computer program product of claim 10, wherein the request is for an organization that is associated with one or more users, the computer program product further comprising instructions that when executed cause the computer system to:
generating buy it again (BIA) data and purchase preferences for the organization using shopping history of the organization generated by the one or more users,
wherein the BIA data and purchase preferences are model inputs used by the machine learned model to determine the segmenting options and their associated costs.

15. The computer program product of claim 14, further comprising instructions that when executed cause the computer system to perform steps comprising:
determining an item of interest to the organization based in part on the BIA data and the purchase preferences for the organization;
predicting a quantity of the item of interest based in part on the BIA data and the purchase preferences for the organization, wherein the quantity exceeds a quantity that can be fulfilled using a single source;
predicting a date that the organization would request delivery for the item;
generating an incentive that provides a discount to pre-order the item if ordered at least a threshold time before the predicted date; and
providing the incentive to the user client device, wherein the user client device presents the incentive.

16. The computer program product of claim 10, wherein retrieving model inputs comprises retrieving one or more of: picker efficiency scores that are associated with the pickers, or sizes of available cargo space in vehicles of the pickers.

17. The computer program product of claim 10, wherein generating a plurality of segmenting options comprises generating a segmenting option for which the combination of sources includes a CPG warehouse.

18. The computer program product of claim 10, wherein generating a plurality of segmenting options comprises generating a segmenting option with a first found rate and a first associated cost, and a second segmenting option with a second found rate and a second associated cost, wherein the first found rate is higher than the second found rate and the first cost is higher than the second cost.

19. A computer system comprising:
a processor; and
a non-transitory computer readable storage medium having instructions encoded thereon that, when executed by the processor, cause the processor to perform steps comprising:
determining that a shopping list from a user client device includes a request for a quantity of an item that exceeds a quantity that can be fulfilled using a single source;
generating a plurality of segmenting options for fulfilling the request using multiple sources, wherein the segmenting options include different combinations of pickers and sources that can be used to fulfill the request;
retrieving model inputs based in part on the request, wherein the model inputs include availability information for the item at various sources;
for each of the plurality of segmenting options, applying a machine learned model to the model inputs to identify an associated cost of the segmenting option;
selecting, based on the identified associated costs of the segmenting options, a segmenting option from the plurality of segmenting options; and
fulfilling the request in accordance with the selected segmenting option, wherein the fulfilling comprises dispatching pickers to sources to fulfill the request according to the combination of pickers and sources of the selected segmenting option.

20. The computer system of claim 19, wherein the request is for an organization that is associated with one or more users, the computer readable storage medium having further instructions encoded thereon that, when executed by the processor, cause the processor to perform steps comprising:
ranking the segmenting options based in part on their associated costs and number of sources to fulfill the request; and
selecting the one or more of the segmenting options based in part on the ranking.
